(19) United States
(12) Patent Application Publication
(10) Pub. No.: US 2014/0151329 A1
(43) Pub. Date: Jun. 5, 2014

(54) FOAM ETCHANT AND METHODS FOR ETCHING GLASS

(71) Applicant: CORNING INCORPORATED, Corning, NY (US)

(72) Inventors: John Martin Dafin, Danville, VA (US); Todd Michael Harvey, Elmira, NY (US); Felipe Miguel Joos, Addison, NY (US); Vasudha Ravichandran, Painted Post, NY (US); Kevin William Uhlig, Horseheads, NY (US); Kathleen Ann Wexell, Corning, NY (US); Christine Coulter Wolcott, Horseheads, NY (US)

(73) Assignee: CORNING INCORPORATED, Corning, NY (US)

(21) Appl. No.: 14/064,275

(22) Filed: Oct. 28, 2013

Related U.S. Application Data
(60) Provisional application No. 61/720,590, filed on Oct. 31, 2012.

(51) Int. Cl. C03C 15/00

(52) U.S. Cl. CPC C03C 15/00
USPC 216/41; 252/79.1; 252/79.3; 216/97

(57) ABSTRACT

A foam acid glass etching media including a solvent; a source of fluorine; and a nonionic surfactant. The foam acid is in the form of a colloidal dispersion with a gas dispersed in a continuous liquid phase. The media is useful in etching or polishing glass sheets in a batch or continuous process. Described is a method for etching or polishing glass by providing a glass having at least one major surface; and contacting the at least one major surface with a foam acid.

### CROSS-REFERENCE TO RELATED APPLICATIONS

This application claims the benefit of priority under 35 U.S.C. §119 of U.S. Provisional Application Ser. No. 61/720,590 filed on Oct. 31, 2012, the content of which is relied upon and incorporated herein by reference in its entirety.

### FIELD

The disclosure relates to foam etchant and methods for etching glass, and more particularly to foam acid etchants and methods of etching glass using foam acid.

### BACKGROUND

Textured glass surfaces are often desirable either for aesthetic purposes or for improved function. For example, nondisplay glass used for keyboard decks or mousepads may be made more attractive by the addition of texture. Display glass such as television cover glass or computer monitor glass may have improved function with the addition of a specific texture which provides antiglare. Etching to provide a texture or pattern typically requires a mask made of a chemically resistant or semi-resistant material.

Immersion etching has been found to have poor reproducibility when masks with either low adhesion or low acid durability are used. Aforementioned masks are used when textures with low haze (shallow etch) are desired.

Wet chemical etching is a common technique for removing surface material. In the case of glass, hydrofluoric acid (HF) attacks the silica network of silicate glasses. Wet etching of glass has been used to provide surface textures such as anti-glare, and also to smooth or polish small defects such as scratches in glass surfaces to improve strength. Cream-based hydrofluoric acid etchants are used by hobbyists for etching decorative designs into glass.

Wet chemical etching can also be applied to metals. The field of microfabrication historically used wet chemical etching to make semiconductors with micron-sized features. Micro patterns can be formed using photolithography and resulting patterns form acid resistant masks for either wet chemical etch or plasma (dry) etching techniques. To etch, silicon wafers are dipped in agitated baths of buffered HF. They typically require the disposal of large amounts of toxic waste. Plasma etching also has drawbacks. In order to form free radicals of fluorine or chlorine near a surface for etching, substrates must be placed in a vacuum chamber. Processes which include vacuum steps are batch processes, not continuous processes, thus are slow and costly.

There exists a need for etching media and methods for etching glass, for example, large glass surfaces using a continuous process which is as fast as wet immersion etching, does not create shear during etching, is low cost, advantageously uses fresh acid for every part, and does not create a lot of hazardous waste.

### SUMMARY

Foams are a unique material with properties of a liquid, a gas, and a solid (as are colloids and emulsions). Foams are considered colloidal dispersions since one phase (liquid) has one dimension between 1-1000 nm and is dispersed in the other phase (gas bubble). As such, foam exhibits physicochemical properties that differ from the component molecules. Foams are also considered “soft matter”; they can hold a shape (as a solid), are soft and pliable, but do not flow as liquid.

Foams are composed of polydisperse gas bubbles separated by draining films. Liquid foams are dynamic, always undergoing drainage due to gravity. Foam can be wet or dry depending on chemistry and generation method. Foams may start out wet with spherical bubbles, and as they drain become dry (<10% liquid). Drainage or gravitational syneresis, occurs at different rates depending on several factors which control foam stability. Foam stability is affected by environment, liquid chemistry, and foam generation technique. Foam stabilizers can be added to enhance foam stability chemically (by cross linking or increasing viscosity), and type of surfactant can affect foam stability. Foams can also be stabilized by the addition of solid particles in the liquid phase.

Drainage results in changes in bubble shape and size from the top to the bottom of the foam layer. This is most apparent when observing a column of foam. As foam becomes dryer toward the top of a foam column, the shapes of bubbles change from spheres to polyhedrons, and bubbles get bigger. Coarsening is the process of gas transfer between bubbles which causes a progressive increase in mean bubble size in polydisperse films.

In pneumatically generated foams, bubble size can be reduced by increasing gas flow rate, reducing liquid viscosity, and/or sparging with smaller porosity. Wetter foams can be made by increasing liquid viscosity and using methods for making smaller bubbles. “Plug” type foams become “recirculation” foams at a certain air flow rate for any type of sparging. Bubbles in plug foams stay in place, where those in recirculating foams move around more (providing a means of liquid mixing).

Drier foams have a higher capacity to cling to vertical surfaces compared with wet foams, making them better candidates for shaving cream, car wash foams, or other applications where “cling” is important.

One embodiment is a glass etching media comprising a foam acid comprising a solvent; a source of fluorine; and a nonionic surfactant, wherein the foam acid is in the form of a colloidal dispersion with a gas dispersed in a continuous liquid phase.

Another embodiment is a method comprising providing a glass having at least one major surface; and contacting the at least one major surface with a foam acid, wherein the foam acid is in the form of a colloidal dispersion with a gas dispersed in a continuous liquid phase.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an illustration of methods according to some embodiments.

FIG. 2 is an illustration of methods and apparatus according to some embodiments.

FIG. 3 is a cross-sectional schematic of a slot deposition applicator tip according to one embodiment.

### DETAILED DESCRIPTION

Reference will now be made in detail to the present embodiment(s), examples of which are illustrated in the accompanying drawings. Whenever possible, the same reference numerals will be used throughout the drawings to refer to the same or like parts.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the application be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B. Exclusive or is designated herein by terms such as “either A or B” and one of A or B″, for example.

The indefinite articles “a” and an are employed to describe elements and components herein. The use of these articles means that one or at least one of these elements or components is present. Although these articles are conventionally employed to signify that the modified noun is a singular noun, as used herein the articles “a” and an also include the plural, unless otherwise stated in specific instances. Similarly, the definite article “the”, as used herein, also signifies that the modified noun may be singular or plural, again unless otherwise stated in specific instances.

For the purposes of describing the embodiments, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that terms like “preferably,” “commonly,” and “typically,” when utilized herein, are not utilized to limit the scope of the claims or to imply that certain features are critical, essential, or even important to the structure or function of the embodiments herein. Rather, these terms are merely intended to identify particular aspects of an embodiment of the present disclosure or to emphasize alternative or additional features that may or may not be utilized in a particular embodiment of the present disclosure.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

“Anti-glare”, “AG”, or like terms refer to a physical transformation of light contacting the treated surface of an article, such as a display, of the disclosure that changes, or to the property of changing light reflected from the surface of an article, into a diffuse reflection rather than a specular reflection. In embodiments, the surface treatment can be produced by mechanical, chemical, electrical, and like etching methods, or combinations thereof. Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques. Typical anti-reflection coatings do not diffuse light; the amount of light that is still reflected from an anti-reflection coating is specular and reflected images are still sharp, though with a lower intensity.

“Contacting” or like terms refer to a close physical touching that can result in a physical change, a chemical change, or both, to at least one touched entity. In the present disclosure various particulate attaching techniques, such as spray coating, dip coating, slot coating, and like techniques, can provide a particulated surface when particulated with particles as illustrated and demonstrated herein. Additionally or alternatively, various chemical treatments of the particulated surface, such as spray, immersion, dipping, and like techniques, or combinations thereof, as illustrated and demonstrated herein, can provide an etched surface when contacted with one or more etchant compositions.

Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{Ros}{Rs} ] \times 100 \qquad ( 1 )$$

where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of ±0.05° centered on the specular direction. Both Rs and Ros were measured using a goniophotometer (Novo-gloss IQ, Rhopoint Instruments) that is calibrated to a certified black glass standard, as specified in ASTM procedures D523 and D5767. The Novo-gloss instrument uses a detector array in which the specular angle is centered about the highest value in the detector array. DOI was also evaluated using 1-side (black absorber coupled to rear of glass) and 2-side (reflections allowed from both glass surfaces, nothing coupled to glass) methods. The 1-side measurement allows the gloss, reflectance, and DOI to be determined for a single surface (e.g., a single roughened surface) of the glass article, whereas the 2-side measurement enables gloss, reflectance, and DOI to be determined for the glass article as a whole. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767, in this instance, the ‘specular direction’ is defined as −20°. The measurement of either DOI or common gloss using the 2-side method can best be performed in a dark room or enclosure so that the measured value of these properties is zero when the sample is absent.

“Transmission haze,” “haze,” or like terms refer to the percentage of transmitted light scattered outside an angular cone of ±4.0° according to ASTM D1003. For an optically smooth surface, the transmission haze is generally close to zero. Transmission haze of a glass sheet roughened on two sides (Haze2-side) can be related to the transmission haze of a glass sheet having an equivalent surface that is roughened on only one side (Haze1-side), according to the approximation of eq. (2):

Haze_{2-side}≈[(1−Haze_{1-side})·Haze_{1-side}]+Haze_{1-side} (2).

Haze values are usually reported in terms of percent haze. The value of Haze2-side from eq. (2) must be multiplied by 100.

Pixel power deviation (PPD) refers to an optical property, similar to sparkle, and viewing is best when sparkle is less than 7%, as measured by a pixel power deviation device. The pixel power deviation device and method of measuring are disclosed in commonly owned and assigned copending patent application Ser. No. 13/354,827.

The term “cling” as used herein may be used to describe a foams property of behaving like a solid and remaining in one location, for example, on vertical or inverted surfaces.

Embodiments of the method describe using a foamed acid “blanket” or coating to etch glass. Acid converted to foam has unique and distinct properties compared with etching with liquid, and these distinctions enable etching with lower cost without loss of speed. Etching with foam can be accomplished with an acid resistant mask or without depending on the resulting texture which is desired. Foam blanket etching can result in the addition of texture or design to glass surfaces when used in conjunction with an acid resistant mask (or when applied to a glass such as soda lime which contains domains of different surface chemistries). This process can also provide polishing of glass surfaces for improved strength.

Methods described herein can be used to etch glass surfaces, for example, for the purpose of providing a modified surface texture (either roughened or polished).

One embodiment is a glass etching media comprising a foam acid comprising a solvent; a source of fluorine; and a nonionic surfactant, wherein the foam acid is in the form of a colloidal dispersion with a gas dispersed in a continuous liquid phase.

Another embodiment is a method comprising providing a glass having at least one major surface; and contacting the at least one major surface with a foam acid, wherein the foam acid is in the form of a colloidal dispersion with a gas dispersed in a continuous liquid phase.

The method can further comprise cleaning the at least one major surface of the glass prior to contacting it with the foam acid. It is advantageous if the glass is cleaned to remove any contaminants or debris.

In one embodiment, the method comprises applying a mask to at least a portion of the at least one major surface of the glass after cleaning the at least one major surface of the glass.

Embodiments can further comprise rinsing the at least one major surface of the glass after contacting it with the foam acid. Rinsing may be accomplished by spray, dip or other methods known in the art. The rinsing time may need to be coordinated with time of foam acid application to ensure equivalent etch across a glass sheet.

Embodiments can further comprise drying the at least one major surface of the glass after rinsing the at least one major surface of the glass. Embodiments can further comprise equilibrating the at least one major surface of the glass to an optimum temperature. In one embodiment, the foam acid comprises a solvent, for example, water; a source of fluorine, for example, hydrofluoric acid, a fluorine salt such as ammoniumfluoride or ammoniumbifluoride, or combinations thereof; and a surfactant, for example, a nonionic surfactant.

Surface active agents (surfactants) are often needed for stable foams. Surfactants may work by lowering surface tension (like soap) or may stabilize by other means (albumen protein in egg white for example). Surfactants are categorized by the polar (hydrophilic) part of the molecule. They can be cationic, anionic or non-ionic, or zwitterionic (depending on the charge of the polar part of the molecule. Surfactants should be chosen for compatibility with liquid solvent and other active agents as well as type of foam generating technique. Nonionic surfactants will not tie up the fluoride ion.

Optionally, the foam acid may also include stabilizers, thickeners, or co-acids, i.e., non-fluorine-containing acids. For example, nitric, sulfuric, hydrochloric, or combinations thereof.

According to one embodiment, the glass etching media comprises from 1.5M to 6M HF. According to one embodiment, the glass etching media comprises from 0.9M to 7M H₂SO₄. According to one embodiment, the glass etching media comprises from 1.5M to 6M HF and from 0.9M to 7M H₂SO₄. According to one embodiment, the glass etching media comprises 0.9M to 7M H₂SO₄. In one embodiment, the glass etching media comprises a surfactant at concentrations high enough to enable stable foam formation and infiltration of mask. Foam acid mixtures can contain water-soluble fluorinated surfactants which can prolong foam acid shelf life (stabilize foam). Fluorinated surfactants are better able to withstand extremely chemically aggressive acid mixtures.

Foam acid mixtures may also contain foam stabilizers such as polyols, polyvinyl alcohol, or combinations thereof. Thickeners from the cellulose ester family such as carboxy methyl cellulose, hydroxypropyl cellulose, or the like can be used.

The foam acid can be generated by mechanical, pneumatic, or venturi methods for mixing gas and liquid to generate the optimal type of foam, for example, optimal percent wetness, bubble size, degree of “cling”. The type of generated foam acid may vary depending on the delivery method and application.

Contacting the at least one major surface with a foam acid can be done using a foam delivery system. A foam blanket or a foam coating can be applied to at least one major surface of a glass sheet. For precision/no shear application on planar surfaces a ram delivery system with precision controls can be used. For nonprecision, 3D, or low etch conditions, spray or other methods would be acceptable. Glass may be held in any position relative to foam applicator, but when not horizontal, may require dryer foam which has an increased cling property as compared to a wetter foam. For example, a drier foam may be coated on underside of the at least one major surface of the glass.

In one embodiment, the method further comprises controlling the temperature of the at least one major surface of the glass sheet. According to one embodiment, the method further comprises controlling the glass temperature prior to the contacting with the foam acid. According to one embodiment, the method further comprises controlling the glass temperature during the contacting with the foam acid. According to one embodiment, the method further comprises controlling the glass temperature during the etching of the glass with the foam acid. According to one embodiment, the method further comprises controlling the foam acid temperature prior to the contacting the glass. According to one embodiment, the method further comprises controlling the foam acid temperature during the contacting with the glass. According to one embodiment, the method further comprises controlling the foam acid during the etching of the glass with the foam acid. The efficacy of foam acid etching may be dependent on foam acid temperature. Uniformity and control of glass temperature or foam acid temperature or both prior to and during application and etching of glass may be advantageous. The at least one major surface of the glass or the glass sheet can be heated or cooled.

Surface tension of a liquid decreases with increasing temperature, reaching 0 at the critical temperature. Foamed liquid in contact with a chilled substrate would have higher surface tension compared with liquid in the rest of the foam.

Temperature can affect the rate of etching, for example, higher temperatures usually increase the rate of etching. The at least one major surface of the glass sheet can be heated by methods of heating known in the art, for example, convection, conduction, infra-red radiation, using a water bath, using running water, an air knife, a convection oven etc. The glass sheet may also be heated throughout the thickness of the glass. In one embodiment, the water bath or running water can be used from the cleaning step.

A practical way of exposing large flat glass surfaces (and potentially 3D glass) to acid is to foam the acid etchant prior to exposure to glass. Foaming is achieved by the addition of surfactant to acid mixture and by using one of several methods for introducing air into the mixture. Foams can be generated in a number of ways, all of which use mixing of gas with a liquid containing surfactant. Methods for mixing gas with liquid can involve blowing gas into liquid or sparging, forming an aerosol, and high shear methods like whipping or beating. Foam generating methods which control wetness of foam as known in the art can be used to introduce air into the mixture to generate foam acid. Foam acid can then be directly applied to glass surfaces by several delivery methods. Delivery methods can be engineered to eliminate shear forces during application. This has value since shear forces can be deleterious to some mask resists. Delivery methods for foam blankets or coatings can be designed to control thickness.

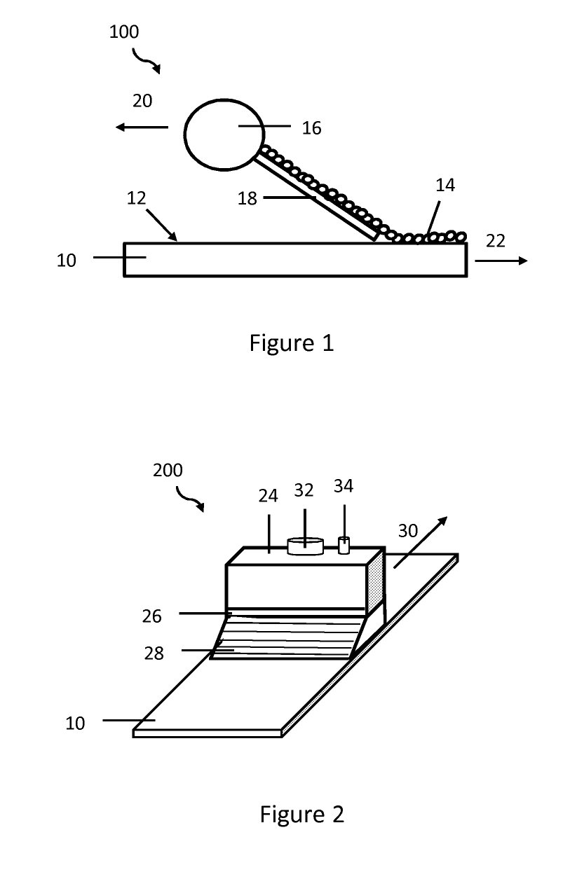

Another embodiment, features 100 of which are shown in FIG. 1, is a method comprising providing a glass 10 having at least one major surface 12, and contacting the at least one major surface with a foam acid 14, wherein the foam acid is in the form of a colloidal dispersion with a gas dispersed in a continuous liquid phase. Optionally, the method further comprises applying a mask to the at least one major surface of the glass prior to contacting with a foam acid.

In one aspect, contacting the at least one major surface with a foam acid comprises delivering the foam acid once generated. The foam acid can be generated and delivered to a delivery apparatus 16 also shown in FIG. 1, for example, a slotted head. The generated foam acid 14 can flow via a transfer apparatus, for example, the slotted head by gravity to the surface of the glass, for example, a glass sheet via a ramp or slide 18. The transfer apparatus (e.g., slide), in one embodiment, hovers just over the glass, but does not contact glass. Either the delivery apparatus 16 or the glass 10 moves laterally, arrows 20 and 22, respectively. The speed of this lateral movement can be equal to the deposition rate of foam. A uniform blanket of foam can be deposited across wide sheets of glass using a single a delivery apparatus such as a continuous slotted head assembly. Foam in this case should be somewhat wet in order to slide off the ramp, and the angle of ramp and ramp material should be optimized to enable sliding of foam.

Foam generation into the delivery apparatus 16 can be performed in a number of ways including but not limited to: sparging, spraying (low or high pressure), shearing, and combinations thereof. By controlling foam generation parameters and surfactant chemistry, the foam generated can be wet or somewhat dry. The shape of the delivery apparatus 16 can be like a reservoir, trough, rounded vessel, V-shaped, or other shape found to provide optimal delivery of foam to the glass surface. The rate of foam generated can be controlled for example by air flow rate for sparging, for example. The rate of foam deposition can be controlled by the foam generation rate or can be independently controlled by another source. The thickness of foam layer can be controlled by an opening height or gate, for example in the slotted head. By controlling the wetness of foam, foam blanket height, and rate of deposition, the total liquid deposited per square cm of glass can be controlled.

Deposition of foam acid blankets can be achieved via spray using multiple nozzles where low etch depths and no mask or resistant masks are employed, and precise amounts of foam are not needed.

In one embodiment, the contacting the at least one major surface with a foam acid comprises etching material away from the at least one major surface and forming a texture on the at least one major surface.

In one embodiment, the contacting the at least one major surface with a foam acid comprises etching material away from the at least one major surface and polishing the at least one major surface.

In one embodiment, the contacting the at least one major surface with a foam acid comprises contacting the foam with the at least one major surface, wherein the at least one major surface is spatially above the foam acid.

In one embodiment, the method further comprises compressing the foam acid before the contacting, during the contacting, or both.

As mentioned earlier in this disclosure, when the substrate is above the foam, it is possible that foam would not deliver the acid at a high enough rate to be effective because gravitational drainage causes the liquid to flow away from the substrate. To compensate for that, a means can be provided to compress the foam so that liquid is actually delivered to the substrate above the foam at the desired rate. While this involves forcing liquid motion on the surface of the glass, the gravitational drainage process on a substrate below the foam itself involves local flow of liquid; so it would be advantageous to establish a rate of compression that is low enough to create uniform etching.

In circumstances where foam compression is unable to compensate for gravitational drainage when the substrate is above the foam, the drainage may be reversed by cooling the glass being etched. As surface tension increases with decreasing temperature, the cooling of the foam near its interface with the substrate would create a gradient in surface tension, drawing liquid towards the glass surface and increasing the thickness of the films as the bubbles in the foam contract, both of which contribute to reversing the effect of gravitational drainage.

According to some embodiments, the glass sheet has a thickness of 4.0 mm or less, for example, 3.5 mm or less, for example, 3.2 mm or less, for example, 3.0 mm or less, for example, 2.5 mm or less, for example, 2.0 mm or less, for example, 1.9 mm or less, for example, 1.8 mm or less, for example, 1.5 mm or less, for example, 1.1 mm or less, for example, 0.5 mm to 2.0 mm, for example, 0.5 mm to 1.1 mm, for example, 0.7 mm to 1.1 mm. Although these are exemplary thicknesses, the glass sheet can have a thickness of any numerical value including decimal places in the range of from 0.1 mm up to and including 4.0 mm.

In some embodiments, the glass is a silicate glass, an aluminosilicate glass, a borosilicate glass, or an aluminoborosilicate glass.

An alternative method and apparatus for applying a foam acid to at least one major surface of a glass sheet is schematically illustrated in FIG. 2. A foam acid coater 200 comprising a foam acid reservoir 24 is positioned in proximity to at least one major surface of a glass 10, in this case a glass sheet, and reservoir 24 including a slot 26 and transfer apparatus (e.g., slide) 28 for delivering foam acid to the surface of the glass sheet to form a foam acid layer.

In one embodiment, the transfer apparatus is textured. The texture can be in a pattern, for example, horizontal or vertical rib structures evenly spaced. The transfer apparatus can be ridged. A ridged transfer apparatus may provide better control of rate of material runoff across the plate.

The foam acid reservoir and transfer apparatus can be set on or attached to a base plate (not shown). In one embodiment, the base plate is a ridged base plate.

For proper foam acid distribution and to minimize contact between the transfer apparatus and surface of glass sheet, the trailing edge of the transfer apparatus makes an angle not exceeding approximately 60°, for example, not exceeding 45° with the surface of the glass sheet and is spaced from about 0.5-10 mm from the surface of the glass sheet during travel of the foam acid coater in the direction indicated by arrow 30. A discharge slot width in the range of about 0.8 to 2.1 mm can insure an adequate flow of foam acid from the reservoir 24. Maintaining a reserve of foam acid in reservoir 24 can be accomplished by adding additional foam acid into the reservoir via inlet 32. Foam acid can be pumped into the inlet, for example. Discharge of the foam acid can be by gravity or by pressurizing the reservoir using a gas via one or more gas inlets 34.

One advantage of foam acid coating in accordance with FIG. 2 can be low momentum of the foam acid as it comes into contact with the surface of the glass. Low shear is due to a coordinated rate of deposition and movement relative to glass and ramp minimizes mask disturbance and possible detachment where an etching mask is present on the deposition surface.

The reservoir assembly is a separate module which fits over the ridged base plate, and can be moved by hand over a glass article by hand at a rate equal to the rate of foam deposition. The acid run plate in this design is ridged to provide better control of rate of material runoff across the plate. The acid run plate is shown at a 45 degree angle in this design. Aspects such as runoff plate material, texture and angle are still being optimized for each types of material.

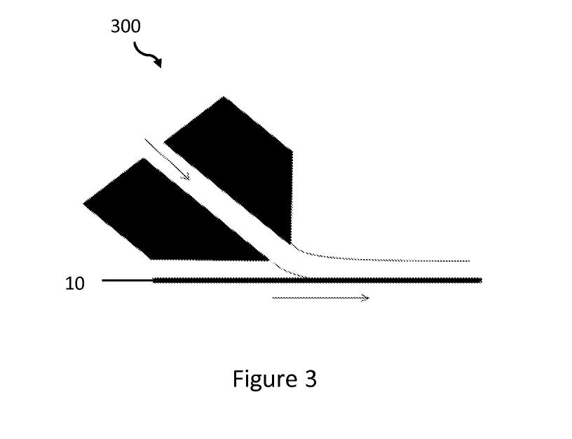

FIG. 3 is a cross-sectional schematic of a slot deposition applicator tip useful in applying foam acid to at least one major surface of glass.

In embodiments where the glass is located above the foam acid delivery apparatus, it is possible that foam would not deliver the acid at a high enough rate to be effective because gravitational drainage may cause the liquid in the foam to flow away from the glass. To compensate for that, a means can be provided to compress the foam so that liquid is actually delivered to the glass above the foam at the desired rate. While this involves forcing liquid motion on the surface of the glass, the gravitational drainage process on a glass below the foam itself involves local flow of liquid; a rate of compression would need to be established that is low enough to create uniform etching.

In another aspect, it may be possible to control acid volume to an absolute minimum level using relatively thin dry foam acid where etch depth is limited by acid volume. In other words, the etch is self-limited by acid volume applied. This method would have the additional advantages of enabling wide etch process times and further decreasing acid consumption.

In circumstances where foam compression is unable to compensate for gravitational drainage when the glass is above the foam, the drainage may be reversed by cooling the glass being etched. As surface tension increases with decreasing temperature, the cooling of the foam near its interface with the substrate would create a gradient in surface tension, drawing liquid towards the glass surface and increasing the thickness of the films as the bubbles in the foam contract, both of which contribute to reversing the effect of gravitational drainage.

In one embodiment, foam acid can be generated by shaking the glass etching media in a container and applying foam acid by hand using a spatula.

Embodiments described herein may provide one or more of the following advantages, for example, as compared with etching in acid baths or spraying recirculated acid: significantly lower acid usage, and lower hazardous waste disposal—this is a benefit, since acid consumption and safe practices for handling acid are primary drivers of etching process cost; acid volume is decrease on two counts: foam blanket has less fluid and surfactant enables etching with lower concentrations of acid; applicable to glass etching processes for texturing and polishing glass: has been demonstrated for a glass texturing application like anti-glare where etch masks are involved; works in polishing/smoothing glass; lower shear forces during application of acid; one time use—no bleed and feed complications; no clogging since no glass residue in lines; bubble blanket would prevent evaporative loss of HF from liquid in blanket except from top bubble film (lamellae); acid will stay where it is placed on glass; safer than acid baths due to lower quantities of acid; compatible with a continuous etch process (acid deposition and washing); control of etch rate via glass temperature may consume less energy and be less complex compared with control of acid liquid temperature; acid with surfactant will have lower surface tension and will wet the glass and mask better than acid without, leading to improved uniformity: acid with surfactant etches faster than acid without (due to breakup of crystalline byproduct on glass surface).

### EXAMPLES

Various embodiments will be further clarified by the following examples. Glass etching media was made by adding distilled (DI) water to a surfactant (Tomamine acid surfactant, available through Air Products and Chemicals, Inc. Allentown, Pa.) in a Nalgene bottle and mixing. The bottle of solution was placed on ice to chill and concentrated (98%) sulfuric acid was added slowly, the solution temperature was kept below 90° C. Concentrated hydrofluoric acid (49%) was added to the solution. The solution was then mixed. The solution was then cooled to 22° C.

All of the foams used in the examples were produced in the same manner; about 100 ml of this solution was poured into a 250 ml Nalgene bottle and shaken vigorously 20 times. Two hand application methods were used to apply foam to glass, these included spreading and sliding. Some of the resulting foam was scooped up using a plastic spatula and applied to a 2×2″ sample of masked glass either by spreading foam (like frosting), or by allowing foam to slide off onto sample while moving the spatula relative to the sample at a rate approximately equal to the sliding rate. In both cases, foam was allowed to sit on glass for approximately 30 seconds, and the glass was rinsed in DI water and dried. Some of the same solutions made with surfactant were also used as unfoamed liquid for immersion etching (examples 8,9,12,13,17,18). Some foamed etchants were used on glass without a mask to determine if foam creates a differential etch without mask (examples 5, 7, and 16). The mask used was a proprietary mask consisting of polymer beads, wax powder and cellulosic binder, applied by aerosol spray, dried, and heated to 80° C. in a conveyorized IR heater (EconomaxD, M&R Sales and Service, Inc., Glen Ellyn, Ill.) to melt wax onto glass.

After etching, and removal of mask, all masked parts with >1M sulfuric acid showed differential etching (textured surfaces), regardless of whether acid was foamed or unfoamed. Significant differential etch can be defined by parts which have DOI of <85%. Glass etched with 6M/1M solution showed very little etch by eye, and almost no texture, having DOI of >85%. Parts etched by a spreading acid foam application had defects not seen in parts with foam applied by sliding. Defects were characterized by round areas with less differential etching and semicircular lines with concave sides facing the direction of spreading. These defects were thought to be due to shear applied to masks.

Table 1 shows exemplary foam acid formulations.

TABLE 1

| Component | 5M/6M | 6M/1M | 5M/6M | 4.5M/4.5M |
|---|---|---|---|---|
| [HF/H₂SO₄] | 0.3% surf. | 3% surf. | 3% surf. | 3% surf. |
| DI water, mL | 494 | 71 | 46 | 56 |
| Tomamine, g | 3 | 3 | 3 | 3 |
| Sulfuric Acid, mL | 333 | 6 | 33 | 25 |
| Hydrofluoric Acid, mL | 173 | 21 | 17 | 16 |

Parts etched by allowing foam to slide off the spatula were uniform in texture in the areas where the foam was applied, but not from part-to-part due to difficulty in uniformity when applying foam by hand. Optical properties of parts are shown in the table below.

Parts etched without a mask were reduced in mass, but showed very little differential etch (high DOI, low haze and PPD). This indicates that the etchant foam effectively enabled contact with a uniform film of acid (otherwise texture would have resulted and caused a decrease in DOI). Typical polishing is performed at 1.5M HF/0.9M H₂SO₄. An etch solution with 6M HF 1M H₂SO₄ was too weak to etch glass significantly. Parts immersed in acid vs. etched by foam had similar optical properties. Glass coupons etched with 5M HF/6M H₂SO₄ mixture containing 3% surfactant etched much faster than with 5M HF/6M H₂SO₄ mixture containing with 0.3% surfactant, indicating a potential for acid savings using surfactant. Parts with acceptable optical properties were achieved using 5M/6M acid with 0.3% surfactant. Table 2 shows optical properties of etched parts.

TABLE 2

| | | Foam Application or | | | | |
|---|---|---|---|---|---|---|
| | | Immersed in unfoamed | | | | |
| Example | Etchant | etch | Mask | DOI | Haze | PPDr |
| 5 | 5/6_0.3% Surfactant | Foamed | no | 99 | 0.1 | 0.9 |
| 1 | 5/6_0.3% Surfactant | Foamed | yes | 57 | 3.9 | 7.4 |
| 2 | 5/6_0.3% Surfactant | Foamed | yes | 50 | 4.2 | 7.7 |
| 3 | 5/6_0.3% Surfactant | Foamed | yes | 52 | 5.1 | |
| 4 | 5/6_0.3% Surfactant | Foamed | yes | 54 | 4.1 | 7.2 |
| 7 | 5/6_3% Surfactant | Foamed | no | 95 | 0.1 | 2.7 |
| 8 | 5/6_3% Surfactant | Immersed | yes | 29 | 44 | 6.1 |
| 9 | 5/6_3% Surfactant | Immersed | yes | 31 | 36 | 7 |
| 10 | 5/6_3% Surfactant | Foamed | yes | 36 | 26 | 6.1 |
| 11 | 5/6_3% Surfactant | Foamed | yes | 27 | 37 | 6.6 |
| 12 | 4.5/4.5_3% Surfactant | Immersed | yes | 40 | 15.2 | 7.5 |
| 13 | 4.5/4.5_3% Surfactant | Immersed | yes | 37 | 16.7 | 7.6 |
| 14 | 4.5/4.5_3% Surfactant | Foamed | yes | 48 | 14.8 | 8 |
| 15 | 4.5/4.5_3% Surfactant | Foamed | yes | 45 | 10.6 | 7 |
| 16 | 6/1_3% Surfactant | Foamed | no | 99 | 0.2 | 2.2 |
| 17 | 6/1_3% Surfactant | Immersed | yes | 97 | 0.2 | 2.2 |
| 18 | 6/1_3% Surfactant | Immersed | yes | 95 | 0.2 | 4.9 |
| 19 | 6/1_3% Surfactant | Foamed | yes | 88 | 0.2 | 4.4 |
| 20 | 6/1_3% Surfactant | Foamed | yes | 94 | 0.2 | 3.1 |

It will be apparent to those skilled in the art that various modifications and variations can be made without departing from the spirit or scope of the disclosure.

What is claimed is:

1. A glass etching media comprising a colloidal dispersion containing a gas dispersed in a continuous liquid phase, wherein the colloidal dispersion comprises a solvent, a source of fluorine, and a nonionic surfactant.

2. The glass etching media according to claim 1, wherein the solvent comprises water.

3. The media according to claim 1, wherein the source of fluorine comprises hydrofluoric acid, a fluorine salt or combinations thereof.

4. The media according to claim 3, wherein the fluorine salt is selected from the group consisting of ammoniumfluoride, ammoniumbifluoride, and combinations thereof.

5. The media according to claim 3, wherein the source of fluorine comprises from 1.5 M to 6 M hydrofluoric acid.

6. The media according to claim 3, further comprising a stabilizer, a thickener, or a co-acid.

7. The media according to claim 6, wherein the co-acid is nitric, sulfuric, or combinations thereof.

8. The media according to claim 7, comprising from 0.9 M to 7 M sulfuric acid.

9. A method comprising contacting a glass having at least one major surface with the glass etching media of claim 1.

10. The method according to claim 9, further comprising controlling the temperature of the at least one major surface of the glass.

11. The method according to claim 9, further comprising controlling the temperature of the glass etching media.

12. The method of claim 9, wherein a mask is applied to the at least one major surface of the glass prior to the contacting.

13. The method according to claim 9, wherein contacting a glass having at least one major surface with the glass etching media comprises moving the glass etching media from a reservoir to a transfer apparatus and transferring the glass etching media from the transfer apparatus onto the at least one major surface of the glass.

14. The method according to claim 9, wherein the contacting the at least one major surface with a foam acid comprises etching material away from the at least one major surface and forming a texture on the at least one major surface, and optionally polishing the at least one major surface.

15. The method according to claim 9, further comprising compressing the foam acid before the contacting, during the contacting, or both.
